(19) United States
(12) Patent Application Publication
(10) Pub. No.: US 2004/0177238 A1
(43) Pub. Date: Sep. 9, 2004

(54) Microprocessor

(75) Inventor: Koutarou Tagawa, Kawasaki-shi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/802,943

(22) Filed: Mar. 18, 2004

Related U.S. Application Data
(62) Division of application No. 09/532,787, filed on Mar. 22, 2000, now abandoned.

(30) Foreign Application Priority Data
Aug. 9, 1999 (JP) 11-224811

(51) Int. Cl. G06F 9/00

(52) U.S. Cl. 712/227

(57) ABSTRACT

A microprocessor which can shorten a testing period and facilitate the production of a test program is provided. The microprocessor of the present invention includes a CPU which performs certain arithmetic operations, an address bus connected to the CPU, a circuit unit, such as comparators, which utilizes an address on the address bus. In an function test of the circuit unit, a test circuit, instead of the CPU, generates a test address for testing the circuit unit through the address bus. Also, a special instruction is issued to transmit an address through the bus so as to prevent the CPU from overrunning

### BACKGROUND OF THE INVENTION

1. Field of the Invention

The present invention generally relates to microprocessors provided with CPUs, and, more particularly, to a microprocessor which can shorten the period of time required for a chip function test.

2. Description of the Related Art

A microprocessor having a CPU core is normally provided with a bus controller for combining an instruction bus and a data bus into one external bus. The instruction bus and the data bus constitute an internal bus connected to the CPU in the chip. FIG. 15 shows a conventional microprocessor. A CPU 102 which performs arithmetic operations is placed on a microcomputer chip 101. An instruction bus 104 and a data bus 105 which constitute an internal bus extend from the CPU 102, and are combined into one external bus 108 by a bus controller 103. The microprocessor has a brake mechanism 106 for braking an instruction address. The brake mechanism 106 comprises a plurality of comparators 109 for comparing addresses, and a brake request generator 110.

Each of the comparators 109 compares an address signal supplied from the instruction bus 104 with a signal supplied from the data bus 105 via a brake point holding register (not shown). A comparison result of each comparator 109 is inputted into the brake request generator 110. In accordance with the comparison result and a set value of a control register (not shown), the brake request generator 110 determines whether or not a brake request signal should be generated. When generating a brake request signal, the brake request generator 110 supplies the brake signal to the CPU 102 via a signal line 107.

After such a microprocessor is produced, an function test is conducted, prior to shipment, to check whether the chip properly operates. In the test, it is also checked whether the comparators 109 connected to the instruction bus 104 properly operate. In the conventional microprocessor, the CPU 102 has a test program, and executes the test program to carry out the function test. The test program is designed to simulate an actual operation of the microprocessor. In a test in accordance with the test program, the CPU needs to. execute several instructions to generate one address to be checked. In a case where there are several addresses to be checked, the number of bits contained in the addresses of instructions executed by the CPU becomes greater, resulting in a longer testing period. Also, to generate a desired instruction address, the program needs to branch to the desired address. If there is no program at the destination address, the CPU will overrun. However, it is very difficult to produce a test program which can prevent the CPU from overrunning, and addresses having similar bit patterns may be used. It is also possible to input an address from outside of the microprocessor, but this causes the microprocessor to operate in a different operation mode from a normal operation mode. In such a case, a reliable test result cannot be expected.

### SUMMARY OF THE INVENTION

A general object of the present invention is to provide microprocessors, in which the above disadvantages are eliminated.

A more specific object of the present invention is to provide a microprocessor which can carry out a reliable function test prior to shipment.

The above objects of the present invention are achieved by a microprocessor comprising:

a CPU which performs certain arithmetic operations;

an address bus connected to the CPU;

a circuit unit which utilizes an address on the address bus; and

a test circuit which generates a test address for testing the circuit unit.

In this microprocessor, the CPU does not function as a bus master during a test. Accordingly, the microprocessor can quickly use the address generated by the test circuit, and the testing period can be greatly shortened.

The above objects of the present invention are also achieved by a microprocessor comprising:

a CPU which performs certain arithmetic operations;

an instruction bus which is connected to the CPU and includes an instruction address bus and an instruction data bus;

a circuit unit which can be tested with the use of an address on the instruction address bus; and

a test circuit which inputs a return instruction into the CPU via the instruction data bus when receiving a branch instruction from the CPU in an initial state immediately after actuation.

In this microprocessor, the CPU receives a return instruction through the data bus in the internal instruction bus. In this manner, the CPU does not capture any other address value. Thus, the CPU can be prevented from overrunning.

The above objects of the present invention are also achieved by a microprocessor provided with a program for fetching an instruction at a predetermined address, and executing an instruction to carry out an unconditional return without using a code at a branch destination as an instruction after a branch occurs to a designated address.

In this microprocessor, an unconditional return operation can be carried out during a test, and it is possible to make the CPU to generate any kind of instruction address. Thus, a test program can be readily produced.

The above objects of the present invention are also achieved by a microprocessor comprising:

a CPU having an instruction bus and a data bus which are independent of each other,

wherein

an instruction to make data read access to the instruction bus is issued.

In this microprocessor, when a desired instruction appears in the memory access stage, the value to be outputted to the address bus is used as a test address, and an function test can be carried out without causing a branch. Thus, the CPU can be prevented from overrunning, and the test program can be readily produced.

The above and other objects and features of the present invention will become more apparent from the following description taken in conjunction with the accompanying drawings.

### BRIEF DESCRIPTION OF THE DRAWINGS

FIG. 1 is a block diagram of a microprocessor of the prior art;

FIG. 2 is a block diagram of a first embodiment of a microprocessor in accordance with the present invention;

FIG. 3 is a block diagram of a brake mechanism of the microprocessor of FIG. 2;

FIG. 4 is a block diagram of a test circuit of the microprocessor of FIG. 2;

FIG. 5 is a block diagram of a second embodiment of the microprocessor in accordance with the present invention;

FIG. 6 is a block diagram of a test result holding register of the microprocessor of FIG. 5;

FIG. 7 is a block diagram of a third embodiment of the microprocessor in accordance with the present invention;

FIG. 8 illustrates a program used in a fourth embodiment of the microprocessor in accordance with the present invention;

FIG. 9 shows a part of the program used in the microprocessor of the fourth embodiment;

FIG. 10 shows a program used in a fifth embodiment of the microprocessor in accordance with the present invention;

FIG. 11 shows a pipeline state in a pipeline operation of the microprocessor of the fifth embodiment;

FIG. 12 is a block diagram of the output unit of the CPU of the microprocessor of the fifth embodiment;

FIG. 13 shows a pipeline state in a pipeline operation of a modification of the microprocessor of the fifth embodiment;

FIG. 14 is a memory map showing a register file of the modification of the microprocessor of the fifth embodiment; and

FIG. 15 is a block diagram of the output unit of the CPU of another modification of the microprocessor of the fifth embodiment.

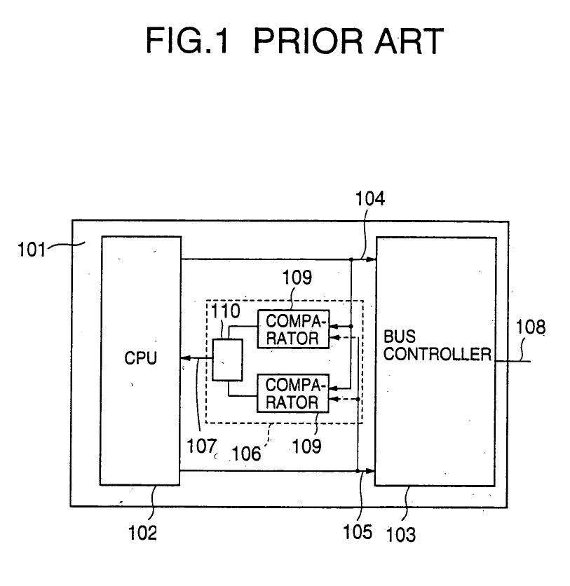

### DESCRIPTION OF THE PREFERRED EMBODIMENTS

The following is a description of embodiments of the present invention, with reference to the accompanying drawings.

First Embodiment

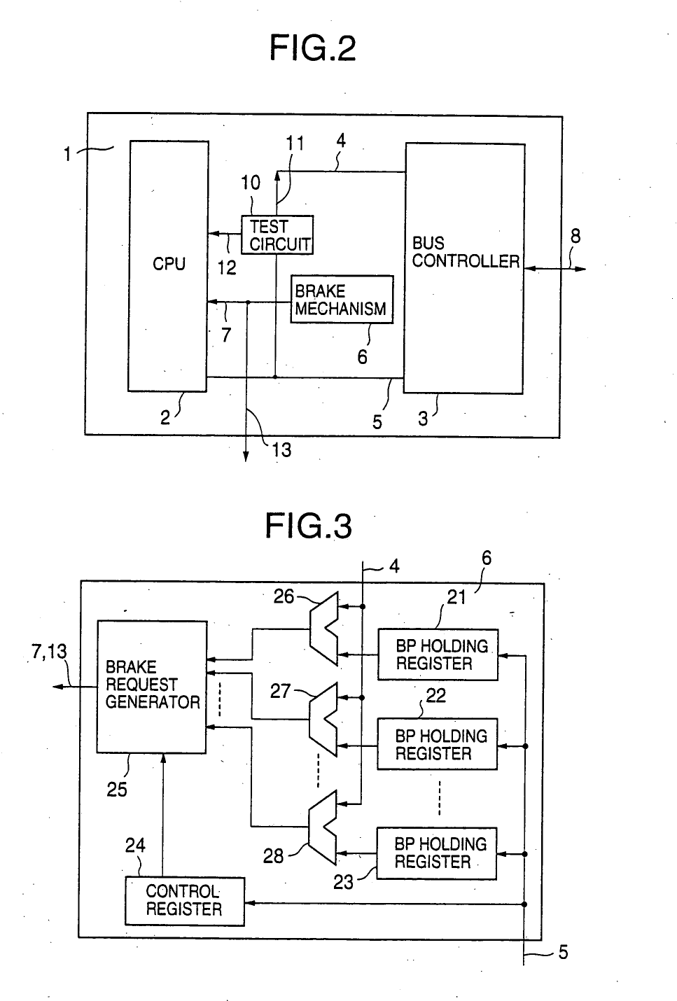

FIG. 2 Shows the structure of a microprocessor 1 of this embodiment. The microprocessor 1 is a device which performs arithmetic operations and is formed on a semiconductor chip. The microprocessor 1 comprises a CPU (Central Processing Unit) 2 for performing arithmetic operations, a bus controller 3 for combining an internal instruction bus 4 and an internal data bus 5 into one internal bus 8, a brake mechanism 6 for braking an instruction address, and a test circuit 10 which generates test addresses in an function test to shorten the testing period of time.

In the microprocessor 1 of this embodiment, the Harvard architecture is employed, with the internal instruction bus 4 and the internal data bus 5 being separate from each other. In a normal operation, the CPU 2 functions as a bus master for the internal instruction bus 4 and the internal data bus 5. Accordingly, the CPU 2 is connected to. the internal instruction bus 4 and the internal data bus 5, inputs and outputs instructions and data through the internal instruction bus 4 and the internal data bus 5, and executes a program stored in its memory.

FIG. 3 shows the inner structure of the brake mechanism 6. As shown in this figure, a plurality of brake point holding registers 21 to 23 are connected to the internal data bus 5, and each hold a value supplied from the internal data bus 5. Although only the three brake point holding registers 21 to 23 are shown in FIG. 3, more of then can be employed. The output signals of the brake point holding registers 21 to 23 are supplied to three comparators 26 to 28, respectively. Like the brake point holding registers 21 to 23, the number of comparators is not necessarily three. The other input terminals of the comparators 26 to 28 are connected to the internal instruction bus 4. Each of the comparators 26 to 28 compares an address value supplied from the internal instruction bus 4 with a value supplied from the internal data bus 5 via each corresponding brake point holding resistor 21, 22, or 23. If the two values are identical, the comparison result is supplied to a brake request generator 25. The brake request generator 25 is connected to a control register 24 also connected to the internal bus 5. In accordance with a control signal supplied from the control register 24, the brake request generator 25 determines whether it should output a brake request to the CPU 2.

In the brake mechanism 6 having the above. structure, the comparators 26 to 28 compare addresses, and output a brake request in accordance with the comparison result. The brake request is supplied to the CPU 2 via a signal line 7. In this embodiment, an function test is conducted to check whether or not the comparators 26 to 28 in the brake mechanism 6 operate properly. More specifically, a test address generated by the test circuit 10 is supplied to the comparators 26 to 28, and an function test is carried out in a short period of time. In the function test, a signal line 13 branching out from the signal line 7 is used to output a test result supplied from the brake mechanism 6.

The test circuit 10 is connected to the internal data bus 5, so that a value from the internal data bus 5 is inputted into the test circuit 10. The test circuit 10 is also connected to the internal instruction bus 4 via a signal line 11, so that the test circuit 10 outputs a test address to the internal instruction bus 4. The test circuit 10 is also connected to the CPU 2 via a signal line 12 to output a signal to the CPU 2. The signal line 12 is used to output signal for providing high impedance to a terminal connected to the internal instruction bus 4 during the function test. This terminal is located in the CPU 2. In the function test, the CPU 2 frees the internal instruction bus 4, so that the internal instruction bus 4 receives a test address from the test circuit 10. The test address is then supplied to each of the comparators 26 to 28 of the brake mechanism 6.

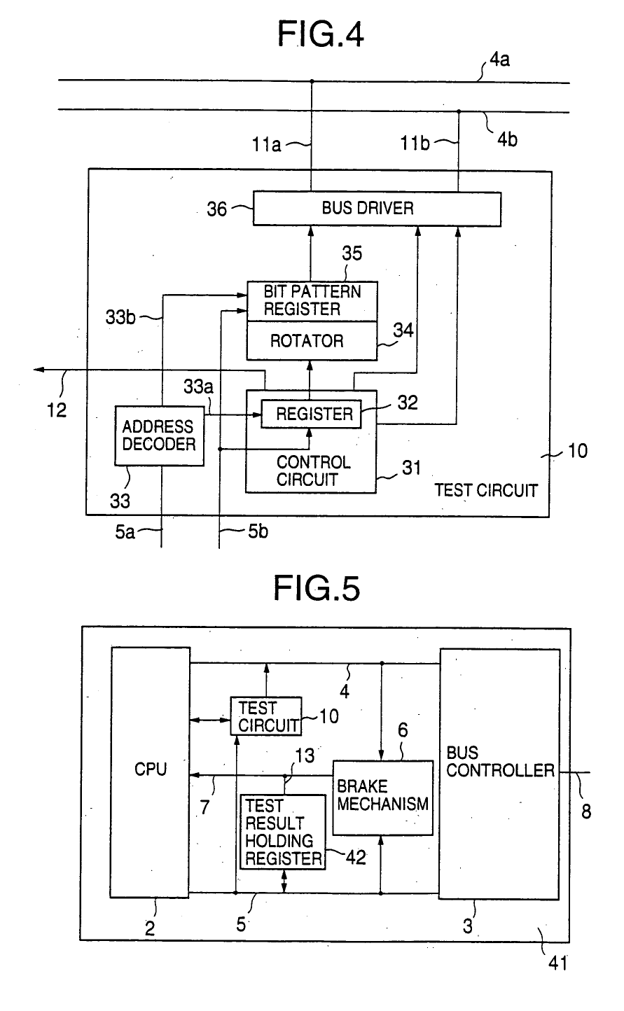

In the function test, the test circuit 10 generates various test addresses. To generate test addresses, any of known techniques can be employed. For instance, a memory table or registers can be used to generate test addresses, or a control technique illustrated in FIG. 4 can be employed. The test circuit 10 supplies test addresses to each of the comparators 26 to 28. In accordance with the test addresses, each of the comparators 26 to 28 supplies a signal to the brake request generator 25. In the function test, the signal line 13 branching out from the signal line 7 is used for transmitting the output from the brake request generator 25. The signal line 13 is allocated to an external terminal of the microprocessor 1, and outputs a test result through the external terminal. Accordingly, whether a test result corresponding to the test addresses generated by the test circuit 10 is obtained can be determined by monitoring the external terminal connected to the signal line 13. During the function test, the CPU 2 stops executing the program. By doing so, the comparators 26 to 28 can be test with the CPU 2 executing no instruction. For instance, one comparator testing operation can be performed per clock.

When the function test is completed, the test circuit 10 outputs, through the signal line 12, a signal to indicate that the test has been completed. Upon receipt of the test completion signal, the CPU 2 frees the terminal from the high-impedance state, and resumes controlling the internal instruction bus 4. Accordingly, after completion of the function test, the CPU 2 resumes functioning as a bus master.

FIG. 4 shows an example structure of the test circuit 10. The test circuit 10 has a control circuit 31 for controlling the test circuit 10. The control circuit 31 contains a control register 32. The control register 32 stores set values, and the control circuit 31 controls each component of the test circuit 10 in accordance with the set values stored in the control register 32. As shown in FIG. 2, the test circuit 10 is connected to the internal data bus 5. More specifically, the internal data bus 5 comprises a data-data bus 5a and a data-address bus 5b, as shown in FIG. 4. The control register 32 is connected to the data-data bus 5b, so that it can fetch the data on the data-data bus 5b as a set value. The data-address bus 5a is connected to an address decoder 33 for inputting a set value from a data bus to the control register 32. The control register 32 fetches a set value in accordance with a write signal outputted from the address decoder 33 via a signal line 33a. The set values may contain the order information.

The address decoder 33 is also connected to a bit pattern register 35 via a signal line 33b. The bit pattern register 35 actually generates the various test addresses. In accordance with a write signal supplied from the address decoder 33, the bit pattern register 35 fetches data from the data-data bus 5b to set a bit pattern. The bit pattern register 35 is coupled with a rotator 34, and can change the bit pattern by the rotator 34. In accordance with the set values set in the control register 32, the rotator 34 sequentially changes the bit pattern outputted from the bit pattern register 35, i.e., a test address.

The test address generated by the bit pattern register 35 is then supplied to a bus driver 36. The bus driver 36 is a circuit for driving the internal instruction bus 4, and is connected to an instruction address bus 4a and an instruction read signal line 4b via signal lines 11a and 11b, respectively. The instruction address bus 4a and the instruction read signal line 4b constitute the internal instruction bus 4. The instruction address bus 4a transfers an address inside the internal instruction bus 4, and, during an function test, transfers a test address generated by the bit pattern register 35. The instruction read signal line 4b transmits an instruction fetch request from the CPU 2. As described before, during an function test, the instruction address bus 4a and the instruction read signal line 4b are controlled by the test circuit 10 instead of the CPU 2. Therefore, the bus driver 36 controls the internal instruction bus 4.

During the function test, the control circuit 31 transmits a bus release request signal to the CPU 2 via the signal line 12. Upon receipt of the bus release request, the terminal of the CPU 2 connected to the internal instruction bus 4 is put into a high-impedance state, and the internal instruction bus 4 is released from the CPU 2. When an function test is not being carried out, however, the test circuit 10 does not send the bus release request to the CPU 2, and the CPU 2 controls the internal instruction bus 4. Meanwhile, the bus driver 36 in the test circuit 10 is connected to the internal instruction bus 4 during an function test, so that the bus driver 36 drives the internal instruction bus 4. When an function test is not being carried out, however, the connection portions between the bus driver 36 and the internal instruction bus 4, i.e., the instruction address bus 4a and the instruction read signal line 4b, are maintained in the high-impedance state. As a result, the contents of an arithmetic operation of the test circuit 10 are not sent to the internal instruction bus 4.

When an function test is not being carried out, the terminal of the bus driver 36 connected to the internal instruction bus 4 is maintained in the high-impedance state. Accordingly, the CPU 2 does not release the internal instruction bus 4, despite a bus release request signal. As a result, the contents of an arithmetic operation of the test circuit 10 are not sent to the internal instruction bus 4.

In an function test, in response to a read signal supplied from the address decoder 33 via the signal lines 33a and 33b, the bit pattern register 35 is set based on the data on the data-data bus 5b. At the same time, the set values to be stored in the control register 32 in the control circuit 31 are also set based on the data on the data-data bus 5b. In accordance with the set values in the control register 32, the test circuit 10 is actuated, and outputs a bus release request signal from the control circuit 31 via the signal line 12. The bus release request signal is inputted into the CPU 2. Upon receipt of the bus release request signal, the CPU 2 puts the connection portions with the internal instruction bus 4 into the high-impedance state, thereby releasing the internal instruction bus 4.

When the bus driver 36 starts controlling the internal instruction bus 4, a test address generated within the bit pattern register 35 is outputted to the bus driver 36, and is further transferred to the instruction address bus 4a. At the same time, an instruction read signal is switched to a signal indicating that an instruction should be fetched in accordance with a signal from the bus driver 36. The instruction read signal is then supplied to all the slaves connected to the instruction address bus 4a. When the instruction read signal is switched, a test address supplied to the instruction address bus 4a is sent to one of the input terminals of each of the comparators 26 to 28. Here, the values held in the brake point holding registers 21 to 23 are compared with the test address supplied from the test circuit, and the comparison result is outputted to the brake request generator 25. At this point, in compliance with the bus release request signal from the test circuit 10, the CPU 2 ignores the brake request signal from the brake request generator 25. As a result, the signal including the test result supplied from the brake request generator 25 is outputted through the signal line 13 to the outside of the chip. The conditions of the comparators 26 to 28 in the brake mechanism 6 can be determined by monitoring the signal outputted through the signal line 13. Since the CPU 2 does not execute the program after the start of the test circuit 10, a very high-speed test can be carried out.

In the test circuit 10, test addresses can be changed in every clock cycle, and the comparator testing can be carried out using difference bit patterns. To change test addresses, the rotator 34 is first actuated by a command from the control circuit 31 so as to shift the contents of the bit pattern register 35 by one bit. More specifically, if the address value of the bit pattern register 35 is 0×00000001 in a previous clock cycle, it shifts to 0×00000002 in a current clock cycle. This shift value is outputted as the address value of the current clock cycle to the internal instruction bus 4. The operations of changing bit patterns includes: adding 1 or a constant value to the address value; subtracting 1 or a constant value from the address value; partially replacing the address value with another value; and erasing the address value. Accordingly, a bit pattern can be composed in accordance with a desired test program.

If the rotator 34 rotates to shift the address value of the bit pattern register 35 by 1 bit, 32 test addresses are generated for a 32-bit microprocessor 6, and the comparison test is carried out for each of the comparators in the brake mechanism 6. After the test, the test circuit 10 is changes the bus release request signal to the other level on the signal line 12, and notifies the CPU 2 of the completion of the test. As a result, the CPU 2 releases its connection portions with the internal instruction bus 4 from the high-impedance state, and resumes executing the program.

As described so far, in the microprocessor 1 of this embodiment, the test circuit 10 controls the internal instruction bus 4 during an function test, thereby disengaging the CPU 2 from comparator testing. Accordingly, the function test can be carried out at a very high speed, and it is possible to input one address value per one clock cycle. Compared with a conventional test method in which addresses are generated within the CPU, the microprocessor 1 of this embodiment can finish an function test in a shorter period of time.

While the test circuit generates test addresses, the CPU 2 puts the connection portions with the address bus into the high-impedance state, and frees itself from the address bus. In this manner, the CPU 2 can output the test result from the device. During an function test, the test addresses generated by the test-circuit 10 can be sequentially outputted by sequentially changing the set values in the bit pattern register 35. This simplifies the address generation during an function test, and the period of time required for the test can be shortened.

Second Embodiment

A microprocessor 41 of this embodiment contains a test result holding register 42. As shown in FIG. 5, the microprocessor 41 of this embodiment comprises the CPU 2 which carries out certain arithmetic operations, a bus controller 3 which combines the internal instruction bus 4 and the internal data bus 5 into the single external bus 8, the brake mechanism 6 which includes the comparators to be tested and brakes an instruction address, the test circuit which generates predetermined test addresses during an function test, and the test result holding register 42 which holds test results. The CPU 2, the internal instruction bus 4, the internal data bus 5, the bus controller 3, the brake mechanism 6, and the test circuit 10 are the same as in the first embodiment.

The test result holding register 42 is connected to the signal line 13 branching out from the signal line 7 extending from the brake mechanism 6 to the CPU 2. The test result holding register 42 temporarily holds test results, and outputs the test results after an function test is completed and the CPU 2 resumes executing the program. The test result holding register 42 is connected so that it can exchange data with the internal data bus 5. After the CPU 2 resumes executing the program, the test result holding register 42 outputs test results through the internal data bus 5, the bus controller 3, and the internal bus 8.

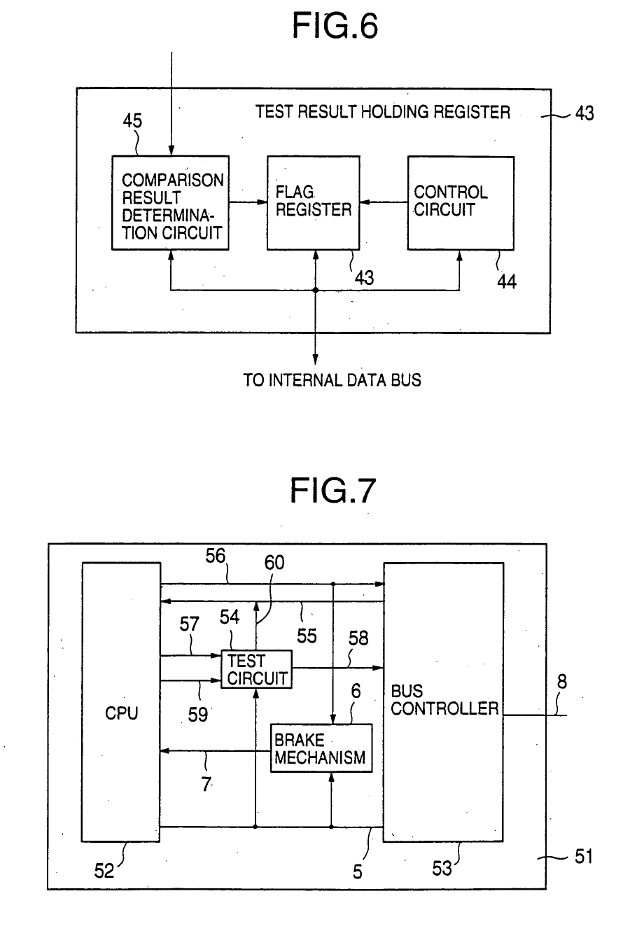

FIG. 6 shows the structure of the test result holding register 42. The test result holding register 42 comprises a comparison result determination circuit 45 connected to the signal line 13, a flag register 43 which stores a synthetic result, and a control circuit 44 which controls the other two circuits 45 and 43. The comparison result determination circuit 45 compares a comparison expected value with the test result of a comparator supplied through the external bus 8 and the internal data bus 5. The comparison result determination circuit 45 is connected to the signal line 13 that supplies the signal of a test result. The output of the comparison result determination circuit 45 is inputted into the flag register 43.

The flag register 43 sets and resets a flag in accordance with the determination result sent from the comparison result determination circuit 45. If the determination result indicates that the comparator is defective, the status of the flag in the flag register 43 is written through the internal data bus 5. In this embodiment, after the CPU 2 resumes executing the program, data outputting becomes possible. When the internal clock is sufficiently faster than the external clock, test result outputting can be effectively carried out. The control circuit 44 supplies a signal for determining the timing of fetching the flag data from the flag register 43, so as to carry out the test result outputting.

In the operation of the test result holding register 42, the CPU first resets the flag in the flag register 43 in accordance with the program, before the start of an function test. More specifically, the CPU 2 accesses the flag register 43 via the internal data bus 5, and resets the flag in the flag register 43 to “0”.

As in the first embodiment, an function test of each of the comparators (not shown) in the brake mechanism 6 is carried out in accordance with the test addresses generated by the test circuit 10. At this point, the internal instruction bus 4 is in a released state, and the CPU 2 is not executing the program. During each function test, the test addresses are sequentially supplied from the test circuit 10 to the comparators in the brake mechanism 6 via the internal instruction bus 4. In this embodiment, an expected value which is expected to be outputted when a comparator is properly operating is inputted for comparison from the external bus 8 into the comparison result determination circuit 45 via the bus controller 3 and the internal data bus 5 in synchronization with the supply of the test addresses. The comparison result determination circuit 45 compares the expected value with each actual test result. If the expected value is not equal to the actual test result, i.e., if the actual test result indicates that the comparator is defective, the comparison result determination circuit 45 supplies a signal to the flag register 43 so as to set the flag in the flag register 43 to “1”. If the actual test results are identical to the respective expected values in all the bit patterns at the test addresses, i.e., if the actual test results indicates that all the comparators have no defects, the comparison result determination circuit 45 sends no signal to the flag register 43, so that the flag in the flag register 43 is maintained at “0”. Especially, since the internal operating frequency is sufficiently higher than the external operating frequency, it is preferable to perform a comparison operation on a plurality of bits inputted from the outside of the chip, instead of performing a comparison operation on one bit at a time. Therefore, a plurality of expected values are collectively inputted so as to facilitate the comparison operations.

After all the test addresses of a series of bit patterns have been outputted, the function test is completed. Upon receipt of a test completion signal from the test circuit 10, the CPU 2 releases the connection portions with the internal instruction bus 4 from the high-impedance state. At the same time, the.bus driver of the test circuit 10 puts the connection portions with the internal instruction bus 4 into a high-impedance state, and the CPU 2 resumes executing the program. As the CPU 2 resumes executing the program, it can read the flag value of the flag register 43 in the test result holding register 42. The CPU 2 then sends the flag value to the outside the chip, and, in accordance with the flag value, it is determined whether or not the comparators are defective.

In the microprocessor 41 of this embodiment, the test result holding register 42 stores the test results of the comparators in the flag register 43, and the test results can also be read out of the flag register 43 and be sent to the outside of the chip. Accordingly, an independent high-speed test on the comparators can be carried out regardless of the external operating frequency, and the test results can be outputted at once to the outside of the chip after the completion of the test. In this manner, the microprocessor 41 of this embodiment can shorten the entire testing period.

Third Embodiment

A microprocessor 51 of this embodiment has a CPU 52 which generates test addresses corresponding to the comparators in the brake mechanism 6 during an function test, and a test circuit 54 which forcibly returns a return signal RET to the CPU 52 so that the CPU 52 can be prevented from overrunning.

As shown in FIG. 7, the microprocessor 51 of this embodiment comprises the CPU 52 which performs certain arithmetic operations, a bus controller 53 which combines an internal instruction bus and the internal data bus 5 into the single external bus 8, the brake mechanism 6 which brakes an instruction address via the signal line 7, and the test circuit 54 which generates predetermined test addresses during an function test so as to shorten the testing period. The brake mechanism 6, the internal data bus 5, and the external bus 8 are the same as in the first and second embodiments.

In the microprocessor 51 of this embodiment, a data bus 55, an address bus 56, and read signal lines 57 and 58 constitute an internal instruction bus. The data bus 55 is used when the CPU 52 fetches an instruction. The address bus 56 transmits the address of each instruction. Since each of the comparators in the brake mechanism 6 compares addresses, the brake mechanism 6 is connected to the address bus 56. In an function test, each of the comparators is tested based on the test addresses supplied from the CPU 52. The read signal lines 57 and 58 transmit an instruction read signal from the CPU 52. When the instruction read signal switches its status, the timing for fetching an instruction is transmitted to each circuit.

Between the CPU 52 and the bus controller 53, the data bus 55 and the address bus 56 are arranged in parallel with each other. The read signal line 57 and 58 extend from the CPU 52 to the bus controller 53, with the test circuit 54 being located therebetween. The read signal line 57 is connected to the test circuit 54, and the read signal line 58 extends from the test circuit 54 for outputting a read signal. Besides the read signal lines 57 and 58, a signal line 59 for receiving a branch generation signal from the CPU 52 and a signal line 60 for transmitting a return instruction RET to the data bus 55.

Unlike the test circuit 10 in the first and second embodiments, the test circuit 54 of the microprocessor 51 of this embodiment does not generate a test address. Instead, the test circuit 54 forcibly replaces the contents of the data bus 55 with a return instruction RET, and supplies it to the CPU 52. When the CPU 52 generates a test address in an actual function test, the CPU 52 receives the return instruction RET from the data bus 55. Accordingly, the CPU 52 does not receive any other address values. Thus, the CPU 52 can be prevented from overrunning during the function test.

The operation of the test circuit 54 will now be described. Assuming that the microprocessor 51 is in an initial state after its production, the CPU 52 starts to execute its program. When the CPU 52 switches to an function test in accordance with the program, the CPU 52 transmits a branch generation signal via the signal line 59 to notify the test circuit 54 of the first branch generation, thereby activating the test circuit 54. As the test circuit 54 is activated, the CPU 52 repeats branching by a call instruction CALL so as to carry out the test on the comparators in the brake mechanism 6. In the branching by the call instruction CALL, the CPU 52 can send a desired test address to the brake mechanism 6. When the CPU 52 switches the read signal to repeat the instruction fetch, the test circuit 54 masks the read signal on the signal line 57 against the signal line 58, and transmits a return instruction RET via the signal line 60. By this signal replacing operation of the test circuit 54, the CPU 52 can certainly return to the original program whether or not a program exist at a test address after branching. Thus, the CPU 52 can be prevented from overrunning.

After the test operation, the test circuit 54 is put into a inactive state by a further change in the branch generation signal or a test completion signal supplied from the CPU 52, and the mask on the read signal on the signal line 57 is removed. In this manner, the CPU 52 can ignore the presence of the test circuit 54, and the read signal is transmitted to each slave via the signal lines 57 and 58. The test circuit 54 is in an active state only when the first branch occurs after the activation of the test circuit 54. The CPU 52 executes the return instruction RET outputted by the test circuit 54, and the test circuit 54 does not react to a branch resulted from the return instruction RET executed by the CPU 52. The test circuit 54 simply returns to the regular test program.

In the microprocessor 51 of this embodiment, the test circuit 54 receives a read signal from the CPU 52, and masks the read signal only when the first branch occurs in the initial state immediately after the activation. After the initial state pass passed, the read signal is used to control the instruction buses. Thus, the CPU 52 can be prevented from overrunning, and the testing time can be shortened.

Fourth Embodiment

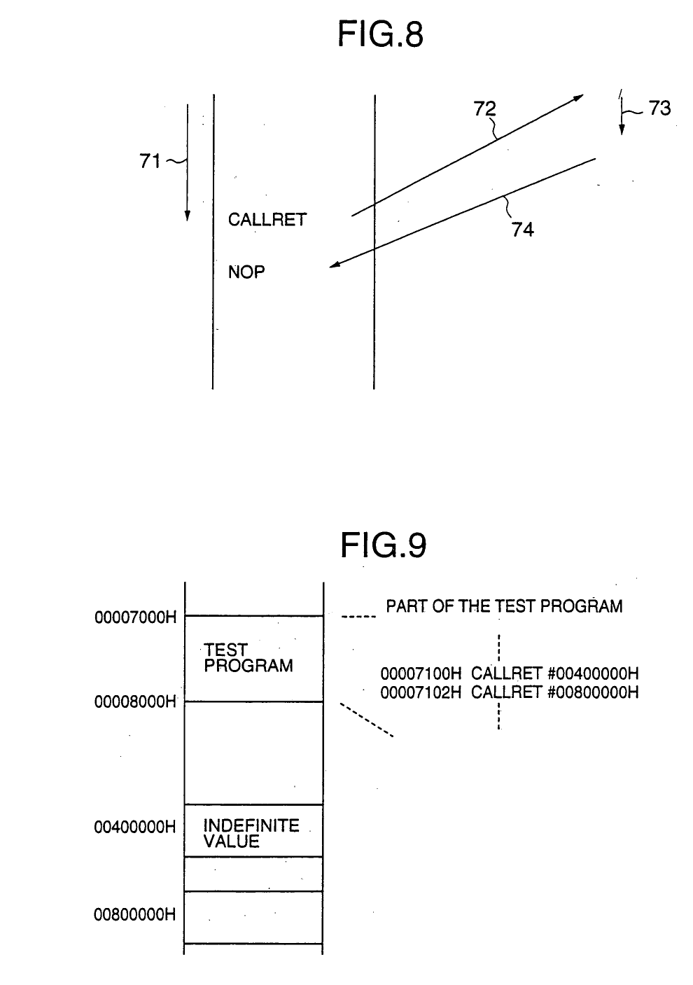

FIG. 8 shows a microprocessor supplied with a special test instruction to be executed by the microprocessor itself. In FIG. 8, a vertical arrow 71 indicates the flow of the program, and a transverse arrow 72 indicates a branch of the program.

In the microprocessor of this embodiment, the test instruction CALLRET is included as one of the instruction codes in the flow of the program. With the special test instruction, the CPU operates as if it were executing a subroutine instruction CALL and a return instruction RET at once. When the CPU of the microprocessor fetches the special test instruction, a branch occurs as indicated by the arrow 72 in FIG. 8, and the CPU then fetches an address corresponding to one instruction code and an instruction. In FIG. 8, an arrow 73 indicates the instruction fetch. The address fetched by the CPU is used as a test address. Unlike in a normal subroutine branch operation, the CPU returns to an address next to the original test instruction CALLRET, as indicated by an arrow 74 in FIG. 8, regardless of what kind of instruction the CPU has fetched.

By the above operation of the microprocessor, a precise return can be carried out, even if no program exists or a non-rewritable program such as a ROM at the branch destination after the test instruction CALLRET is executed. Accordingly, the CPU can generate any instruction address, and the test patterns can be very easily produced. Although the special test instruction is called CALLRET in this embodiment, any other name can be used for the instruction as long as it does not coincides with another instruction code.

FIG. 9 shows an example program executed by the microprocessor of this embodiment. In this program, a test program is written between an address “00007000H” and an address “00008000H”. In this test program, the test instruction CALLRET is written. In this example, the test instruction CALLRET is written at an address “00007100H” and an address at “00007102H” in the test program. The CPU executing this program requires two addresses for one instruction. When the CPU fetches the instruction CALLRET at the address “00007100H”, it also fetches a branch destination address “00400000H” at the same time. Accordingly, the program branches to the address “00400000H”, and the address “00400000H” is sued as the address value in the test.

The CPU then outputs the address “00400000H” as an instruction address, and carries out the instruction fetch at the destination address. However, the CPU does not use thee instruction code as an instruction, and unconditionally performs the return operation. Even if the instruction at the address “00400000H” is an indefinite value, as shown in FIG. 9, the program unconditionally returns to the address “00007102H” next to the branch originating address “00007100H”. If the instruction at the address “00007100H” is a normal branch instruction CALL, the CPU fetches the indefinite value at the address “00400000H”, and starts overrunning. In this embodiment, however, the test instruction CALLRET is used instead of the branch instruction CALL. Thus, the CPU can be prevented from overrunning.

After returning to the address “00007102H”, the CPU branches to an address “00800000H” in accordance with the test instruction CALLRET, and supplies the address value as a test address to the comparators. Without using the instruction code at the branch destination as an instruction, the CPU again unconditionally returns to an address “00007104H”.

As described above, by the test instruction CALLRET, the CPU unconditionally returns from the branch destination without executing the instruction code at the branch destination as an instruction, regardless of what instruction address the CPU is made to generate. Thus, the CPU can be prevented from overrunning, and a reliable function test can be carried out. Also, it is not necessary to produce a test program in this embodiment. Since test instructions can be continuously arranged, the testing period can be shortened.

Fifth Embodiment

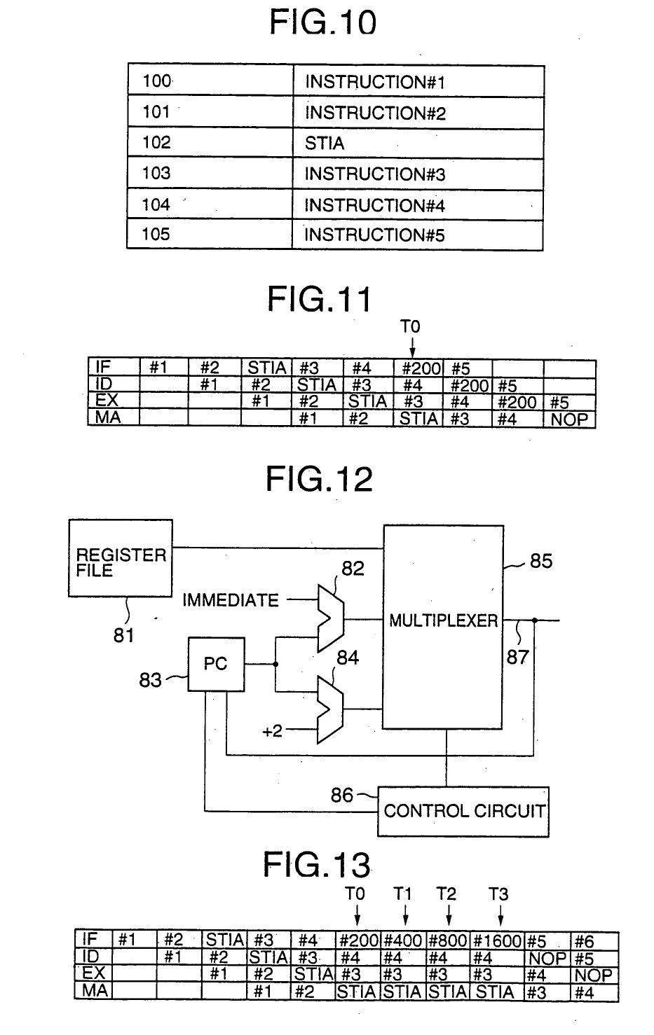

A microprocessor of this embodiment can execute an instruction to make simulative data access to the instruction bus. FIG. 10 shows an example program stacked in a memory. This program starts at an address “100” and ends at an address “105”. One instruction is stored at each address: an instruction “#1” is stored at the address “100”, an instruction “#2” at the address “101”, an instruction “#3” at the address “103”, an instruction “#4” at the address “104”, and an instruction “#5” at the address “105”. In this example program, an instruction STIA to make simulative data access to the instruction bus is stored at the address “102”.

FIG. 11 shows a pipeline state in the CPU of the microprocessor of the fifth embodiment. In this figure, IF stands for an instruction fetching stage, ID stands for an instruction decoding stage, EX stands for an instruction executing stage, and MA stands for an instruction memory access stage. In a case where the CPU executes the program shown in FIG. 10 by pipeline processing, the CPU processes the instructions in the address order. When the instruction STIA stored at the address “102” appears in the memory access stage MA, the address that is originally to be outputted to the address bus in the data bus is outputted to the address bus in the instruction bus. As a result, at the time T0 when the instruction STIA appears in the memory access stage MA, the value “#200” that is originally to be outputted to the address bus in the data bus appears in the instruction fetching stage IF, and can be used as a test address in an function test. When the CPU executes the instruction STIA, it ignores the instruction code of the address (“#200” in this example) written on the instruction bus, and regards the decode stage ID, the execution stage EX, and the memory access stage MA as non-operation stages.

With the use of the instruction STIA, an function test without causing a branch can be carried out by the microprocessor of this embodiment. If the program executed by the CPU branches to a subroutine, more clock cycles are required, resulting in low-speed operation. On the other hand, if a test address is transmitted to the instruction bus without causing a branch during the execution of the program, a high-speed operation can be realized. Furthermore, only necessary.-addresses can be transmitted to the instruction bus at desired timing, regardless of the previous and following instructions in the program. Thus, the test patterns can be simplified, and an function test can be more efficiently carried out.

FIG. 12 shows the structure of the instruction address output unit of the CPU, which executes the instruction STIA. The instruction address output unit comprises an internal general register file 81, a branch adder 82 for branching to a relative address in a program counter, a program counter 83 which stores values for designating execution addresses in the program, a PC incrementer 84 which adds the address values of instructions not involving a branch, a multiplexer 85 which selects an address value to be outputted to an instruction address bus 87, and a control circuit 86 which controls the operations of the program counter 83 and the multiplexer 85.

The CPU in this embodiment needs to input an address value into the register in the CPU to designate a branch destination at an absolute address. When a branch to an absolute address occurs, the address value of the absolute address is transferred from the internal general register file 81 to the multiplexer 85. The program counter 83 is connected to the instruction address bus 87, and latches an address value stored in the instruction address bus 87. However, the latch timing is controlled by the control circuit 86. In other words, an instruction address outputted from the CPU is also stored in the program counter 83 in preparation for the next instruction fetch. The branch adder 82 performs an add operation for instructions to branch to a relative address of the program counter, and the PC incrementer 84 adds 2 to the address value supplied from the program counter 83 when the instruction does not involve a branch. The multiplexer 85 selects an address value from the general register file 81, the branch adder 82, and the PC incrementer 84. The selected address value is outputted to the instruction address bus 87.

When a normal instruction is executed in the instruction address output unit of the CPU having the above structure, the output of the PC incrementer 84 is used as the address value to be outputted to the instruction address bus 87, as long as it does not involve a branch. When an instruction to branch to a relative address of the program counter is executed, the output of the branch adder 82 is used as the address value to be outputted to the instruction address bus 87. As for an instruction to branch to an absolute address, the output of the general register file 81 is used as the address value to be outputted to the instruction address bus 87. Here, the program counter 83 latches the address value on the instruction address bus 87 in accordance with a control signal supplied from the control circuit 87.

In a case where the test instruction STIA is executed, a designated address value (the address “#200” in the example shown in FIG. 11) is read from the general register file 81, and is selected by the multiplexer 85 in accordance with the control signal supplied from the control circuit 86. The selected address value is then outputted as an instruction address to the instruction address bus 87. The address value is used as a test address in the comparator test. In this case, the program counter 83 does not latch the address value on the instruction address bus 87. At the time of fetching of the instruction STIA, the CPU regards it as a non-operation instruction, and operates accordingly. When the test address based on the instruction STIA is outputted, the PC incrementer 84 adds 2 to the address value stored in the program counter 83, and the incremented address value is used as an instruction address after the output of the test address. By the add operation by the PC incrementer 84, the normal instruction fetch operation is resumed.

As described above, when executing the instruction STIA, an instruction code fetched during the execution is simply discarded without being used as an instruction code in the CPU. Even if a meaningless code in the program is returned, the CPU will not overrun. Thus, any instruction address can be used in a test program, and a more efficient function test can be carried out.

Sixth Embodiment

FIG. 13 shows a pipeline state in a pipeline process carried out by a microprocessor of the sixth embodiment. In FIG. 13, IF stands for an instruction fetching stage, ID stands for an instruction decoding stage, EX stands for instruction execution stage, and MA stands for an instruction memory access stage. In this embodiment, the instruction STIA is inputted in the memory access stage MA four times, and four addresses to be outputted to the address bus of the data bus is outputted to the address bus of the instruction bus. Since four instructions STIA are stored in the memory access stage MA, the following instructions “#4” and “#3” are also stored in the instruction decoding stage ID and the instruction executing stage EX, respectively. At the time T0 when the instruction STIA first appears in the memory access stage MA, the address value “#200” appears in the instruction fetching stage IF, as in the microprocessor of the fifth embodiment. At the times T1 to T3, address values “#400”, “#800”, and “#1600” are outputted and used as test addresses. While the test addresses are transmitted, each instruction code at the addresses (“#400”, “#800”, and “#1600”, in this embodiment) written in the instruction bus is ignored, and the following instruction decoding stage ID, the instruction executing stage EX, and the memory access stage MA are regarded as non-operation stages. After the four addresses have been outputted, the normal instruction execution is resumed.

By using the instruction STIA, a high-speed function test involving no branch can be carried out in the microprocessor of this embodiment. Since only necessary addresses can be outputted into the instruction bus at desired timing regardless of the previous and following instructions in the program, test patterns can be easily designed, and an function test can be efficiently carried out. Also, as a plurality of addresses can be outputted into the instruction bus by the use of the instruction STIA, an function test can be carried out in a shorter period of time.

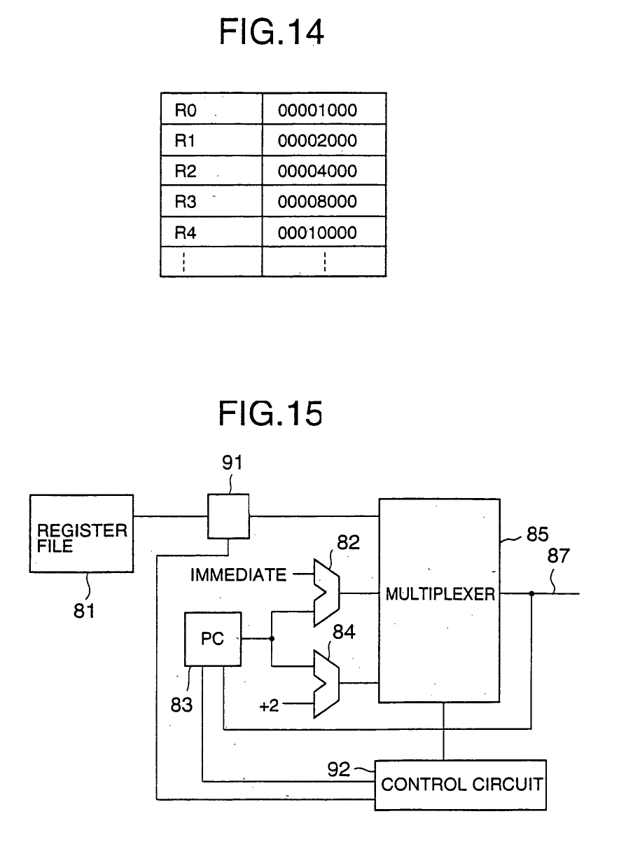

FIG. 14 shows the set contents of the general register file 81 shown in FIG. 12. In this example, the instruction STIA can be programmed as R0, R1, R2, R3, R4, . . . , and address values corresponding to the parameters are outputted into the instruction bus. The control circuit 86 controls the address outputting so that the addresses corresponding to designated parameters are outputted. Thus, a plurality of addresses can be outputted with the single instruction STIA.

FIG. 15 shows a modification of the instruction address output unit of FIG. 12. Besides the register file 81, the relative address branch adder 82, the program counter 83, the PC incrementer 84, and the multiplexer 85 that selects an address value to be outputted to the instruction address bus 87, the instruction address output unit of this modification comprises a rotator 91 and a control circuit 92. The rotator 91 is controlled by the control circuit 92 to calculate and output an address value.

The rotator 91 is interposed between the general register file 81 and the address bus of the multiplexer 85. The rotator 91 rotates data read from the register file 81 rightward or leftward by one or more bits, or inverts the data. The rotator 91 then outputs the rotated or inverted data to the multiplexer 85. The operation of the rotator 91 can be determined based on an instruction signal supplied from the control circuit 92.

The instruction address output unit operates in the same manner as the instruction address output unit shown in FIG. 12. However, when the instruction STIA is inputted, the rotator 91 operates in accordance with an instruction supplied from the control circuit 92. After the register file 81 outputs an address, the rotator 91 rotates the address value by a predetermined number of bits. This address outputting and rotating are repeated, so that a plurality of addresses can be outputted to the instruction bus with the single instruction STIA. Thus, an function test can be carried out in an even shorter period of time. Also, one address value is sufficient in the register file 81, because the rotator 91 rotates and inverts the address value to obtain various address values to produce a test program. Thus, a test program can be more easily produced.

When the instruction STIA is decoded in the microprocessor of the sixth embodiment, data access to the instruction bus is made several times, and a plurality of test address stored in the register in the CPU are outputted to the instruction bus. The plurality of test address may be easily obtained by processing a value stored in the register in the CPU by the use of a rotator. With the microprocessor of this embodiment, a high-speed function test can be carried out, and the testing period can be greatly shortened. Also, a test program can be easily produced.

As described so far, with the microprocessor of the present invention, an function test can be carried out without causing the CPU to overrun, regardless of the instruction addresses allotted. Accordingly, it is unnecessary to set irrelevant parts in a test program. Thus, a test program can be produced in a short period of time. Furthermore, since the actual testing period can be shortened, the productivity can be greatly increased.

In the above embodiments, the comparators in the brake mechanism are tested. However, the present invention can be applied to a test of a circuit which operates with a signal, such as an instruction address, for which a bit pattern cannot easily produced.

The present invention is not limited to the specifically disclosed embodiments, but variations and modifications may be made without departing from the scope of the present invention.

The present application is based on Japanese priority application No. 11-224811, filed on Aug. 9, 1999, the entire contents of which are hereby incorporated by reference.

What is claimed is:

1. A microprocessor comprising:
a CPU which performs certain arithmetic operations;
an address bus connected to the CPU;
a circuit unit which utilizes an address on the address bus; and
a test circuit which generates a test address for testing the circuit unit.

2. The microprocessor as claimed in claim 1, further comprising a brake mechanism which comprises:
a plurality of comparators which compare addresses supplied;
a control register which receives the outputs of the plurality of comparators; and
a brake request generator which outputs a brake request to the CPU in accordance with a control signal supplied from the control register.

3. The microprocessor as claimed in claim 1, wherein the test circuit comprises:
a control circuit which contains a register storing control values;
an address decoder which receives the control values from the control circuit;
a bit pattern register which generates a bit pattern to produce a test address;
a rotator which makes a change to the bit pattern; and
a bus driver which receives the test address and drives the address bus.

4. The microprocessor as claimed in claim 1, further comprising a test result holding register which holds test results and comprises:
a comparison result determination circuit which compares actual test results with expected values;
a flag register which receives and stores the output of the comparison result determination circuit; and
a control circuit which controls the comparison result determination circuit and the flag register.

5. A microprocessor comprising:
a CPU which performs certain arithmetic operations;
an instruction bus which is connected to the CPU and includes an instruction address bus and an instruction data bus;
a circuit unit which can be tested with the use of an address on the instruction address bus; and
a test circuit which inputs a return instruction into the CPU via the instruction data bus when receiving a branch instruction from the CPU in an initial state immediately after actuation.

6. A microprocessor comprising:
a program for fetching an instruction at a predetermined address, and executing an instruction to carry out an unconditional return without using a code at a branch destination as an instruction after a branch occurs to a designated address.

7. A microprocessor comprising:
a CPU having an instruction bus and a data bus which are independent of each other,
wherein
an instruction to make data read access to the instruction bus is issued.
